(19) United States
(12) Patent Application Publication
(10) Pub. No.: US 2009/0219227 A1
(43) Pub. Date: Sep. 3, 2009

(54) Plasma display device

(76) Inventor: Kunio Takayama, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/379,187

(22) Filed: Feb. 13, 2009

(30) Foreign Application Priority Data
Feb. 28, 2008 (KR) 10-2008-0018370

(51) Int. Cl. G09G 3/28

(52) U.S. Cl. 345/60

(57) ABSTRACT

A plasma display device that prevents a luminance difference between scan lines by preventing an output voltage fluctuation in output lines connected to a scan IC. The plasma display device includes a plasma display panel having sustain electrodes, scan electrodes, and address electrodes, which are arranged to correspond to discharge cells to selectively drive the discharge cells, a chassis base supporting the plasma display panel, at least one printed circuit board mounted on the chassis base, and at least one flexible printed circuit connecting the scan electrodes to the printed circuit board. The flexible printed circuit includes input lines connecting at least one scan integrated circuit to the printed circuit board, output lines connecting the at least one integrated circuit to the scan electrodes, and ground lines that are formed beside outer sides of outermost output lines among the output lines to ground the at least one scan integrated circuit.

### CLAIM OF PRIORITY

This application makes reference to, incorporates the same herein, and claims all benefits accruing under 35 U.S.C. §119 from an application earlier filed in the Korean Intellectual Property Office on Feb. 28, 2008 and there duly assigned Serial No. 10-2008-0018370.

### BACKGROUND OF THE INVENTION

1. Field of the Invention

The present disclosure relates to a plasma display device. More particularly, the present disclosure relates to a plasma display device that is configured to prevent a luminance difference between scan lines by preventing fluctuation of output voltage of output lines connected to a scan integrated circuit.

2. Description of the Related Art

Generally, a plasma display device includes a plasma display panel (PDP) forming an image, a chassis base supporting the PDP, and a plurality of printed circuit boards (PCBs) mounted on the chassis base and connected to the PDP.

The PDP generates plasma using gas discharge, excites phosphors using vacuum ultra-violet rays emitted from the plasma, and realizes an image using red, green, and blue visible lights that are generated as the excited phosphors are stabilized.

In order to induce the gas discharge, the PDP includes address electrodes and display electrodes (e.g., sustain electrodes and scan electrodes). The address electrodes intersect the display electrodes at regions corresponding to discharge cells. The address electrodes, the sustain electrodes, and the scan electrodes are connected to the corresponding PCBs through flexible printed circuits (FPCs).

For example, the PCBs include a sustain board for controlling the sustain electrodes, a scan board for controlling the scan electrodes, and an address buffer board for controlling the address electrodes. The scan board is connected to the FPC to independently control the scan electrodes. The FPC mounting a scan integrated circuit (scan IC) is one of a chip-on-film (COF) or a tape carrier package (TCP).

The scan electrodes are connected to the scan boards by the plurality of FPCs. That is, the scan electrodes are classified into a plurality of groups and the FPCs are provided to correspond to the respective groups.

With reference to one FPC, each of the outermost output lines has a first side to which no output line is adjacent and a second side to which an output line is adjacent. Therefore, the outermost output lines have relatively lower electrostatic shielding effect as compared with inner output lines that have output lines on either side. Therefore, the outermost output lines of the FPC have higher output waveform fluctuation as compared with the inner output lines, thereby increasing voltage fluctuation.

As a result, the outermost output lines increase discharge time fluctuation. Therefore, scan lines (i.e., scan electrodes) connected to the outermost output lines induce a lower luminance as compared with the scan lines connected to the inner output lines.

With reference to two adjacent FPCs, the scan lines connected to the outermost output lines of one of the adjacent FPCs and the scan lines connected to the outermost output lines of the other of the adjacent FPCs successively induce the lower luminance.

Therefore, the luminance induced by the scan lines connected to the outermost output lines of the adjacent two FPCs is significantly lower than the luminance induced by the scan lines connected to the inner output lines. The luminance difference between the scan lines results in a horizontal image streaking in the PDP.

The above information disclosed in this Background section is only for enhancement of understanding of the background of the invention and therefore it may contain information that does not form the prior art that is already known in this country to a person of ordinary skill in the art.

### SUMMARY OF THE INVENTION

Exemplary embodiments of the present disclosure provide a plasma display device that is configured to prevent a luminance difference between scan lines by preventing output voltage fluctuation in output lines connected to a scan IC.

Exemplary embodiments of the present disclosure also provide a plasma display device that is designed to prevent a horizontal image streaking in a PDP by making luminance of scan lines connected to outermost output lines of two adjacent FPCs and luminance of scan lines connected to other output lines of the two adjacent FPCs uniform.

According to an exemplary embodiment of the present disclosure, a plasma display device includes a plasma display panel having sustain electrodes, scan electrodes, and address electrodes, which are arranged to correspond to discharge cells to selectively drive at least one of the discharge cells, a chassis base supporting the plasma display panel, at least one printed circuit board mounted on the chassis base, and at least one flexible printed circuit connecting the scan electrodes to the printed circuit board. The flexible printed circuit may include a plurality of input lines connecting at least one scan integrated circuit to the printed circuit board, a plurality of output lines connecting the at least one integrated circuit to the scan electrodes, and ground lines that are formed beside outer sides of outermost output lines among the output lines to ground the at least one scan integrated circuit.

Each of the scan electrodes may include a terminal line and an interconnection line connected to the terminal line, and the plasma display panel may include a terminal region where the terminals are formed and an interconnection line region where the interconnection lines are formed. At this point, the ground lines may be in parallel with the outermost output lines at predetermined intervals and extend from the scan IC to the terminal region.

Each of the ground lines may have a first extending portion extending from the terminal region to the interconnection line.

The at least one flexible printed circuit may include a first flexible printed circuit and a second flexible printed circuit that are adjacent to each other. At this point, the extending portions of the adjacent ground lines of the first and second flexible printed circuits may be connected to each other.

The extending portions of the adjacent ground lines of the first and second flexible printed circuits may be connected to an enlarged portion formed at the interconnection line region.

Each of the ground lines may include an enlarged portion formed at the terminal region.

When the at least one flexible printed circuit includes a first flexible printed circuit and a second flexible printed circuit that are adjacent to each other, the enlarged portions may include a first enlarged portion and a second enlarged portion connected to each other. The first enlarged portion is connected to the ground line of the first flexible printed circuit, and the second enlarged portion is connected to the ground line of the second flexible printed circuit.

A width of each of the ground lines may be greater than that of each of the output lines.

The plasma display device may further include a heat dissipation member attached on a surface of the at least one scan integrated circuit.

The ground lines penetrate the flexible printed circuit and are grounded to the heat dissipation member.

When the at least one flexible printed circuit includes first and second flexible printed circuits that are adjacent to each other, the heat dissipation member may include first and second heat dissipation members respectively corresponding to the first and second flexible printed circuits.

When the at least one flexible printed circuit includes first and second flexible printed circuits adjacent to each other, the heat dissipation member is provided in the form of a single unit that simultaneously covers the first and second flexible printed circuits.

The flexible printed circuit mounting the at least one scan integrated circuit may be one of a chip-on-film (COF) and a tape carrier package (TCP).

According to another exemplary embodiment, a plasma display device includes a plasma display panel having sustain electrodes, scan electrodes, and address electrodes, which are arranged to correspond to discharge cells to selectively drive at least one of the discharge cells, a chassis base supporting the plasma display panel, a scan board mounted on the chassis base, a scan buffer board mounting at least one scan integrated circuit and connected to the scan board, and at least one flexible circuit board connecting the scan electrodes to the scan buffer board. The flexible printed circuit includes a plurality of output lines connecting the at least one integrated circuit to the scan electrodes, and ground lines that are respectively formed beside outer sides of outermost output lines among the output lines to ground the at least one scan integrated circuit.

The ground lines may be grounded to the scan buffer board.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is an exploded perspective view of a plasma display device according to a first exemplary embodiment of the present disclosure.

FIG. 2 is a front view of a PDP, a sustain board, and a scan board of FIG. 1, which are connected by FPCs and unfolded.

FIG. 3 is a partial perspective view of a PDP and scan board of FIG. 1, which are connected by FPCs.

FIG. 4 is a detailed view illustrating a connection state of FPCs and scan electrodes of FIG. 1.

FIG. 5 is a detailed view illustrating a connection state between FPCs and scan electrodes of a plasma display device according to a second exemplary embodiment of the present disclosure.

FIG. 6 is a detailed view illustrating a connection state between FPCs and scan electrodes of a plasma display device according to a third exemplary embodiment of the present disclosure.

FIG. 7 is a detailed view illustrating a connection state between FPCs and scan electrodes of a plasma display device according to a fourth exemplary embodiment of the present invention.

FIG. 8 is a partial perspective view illustrating a connection state of a PDP, a scan buffer board, and a scan board by FPCs in a plasma display device according to a fifth embodiment of the present invention.

### DETAILED DESCRIPTION OF THE EMBODIMENTS

The present disclosure will be described more fully hereinafter with reference to the accompanying drawings, in which exemplary embodiments of the invention are shown. As those skilled in the art would realize, the described embodiments may be modified in various different ways, all without departing from the spirit or scope of the present disclosure. The drawings and description are to be regarded as illustrative in nature and not restrictive. Like reference numerals designate like elements throughout the specification.

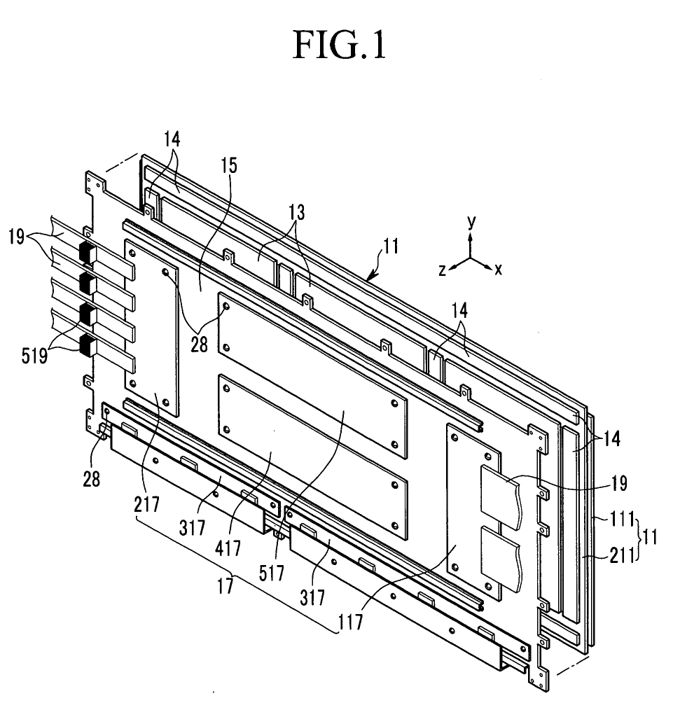

FIG. 1 is an exploded perspective view of a plasma display device according to a first exemplary embodiment of the present disclosure.

Referring to FIG. 1, a plasma display device includes a plasma display panel (PDP) 11 displaying an image, a plurality of heat dissipation sheets 13, a chassis base 15, a plurality of PCBs 17, and a plurality of FPCs 19.

Exemplary embodiments of the present disclosure relate to a coupling structure between the PDP 11 and other components. Therefore, a detailed description of the PDP will be omitted herein.

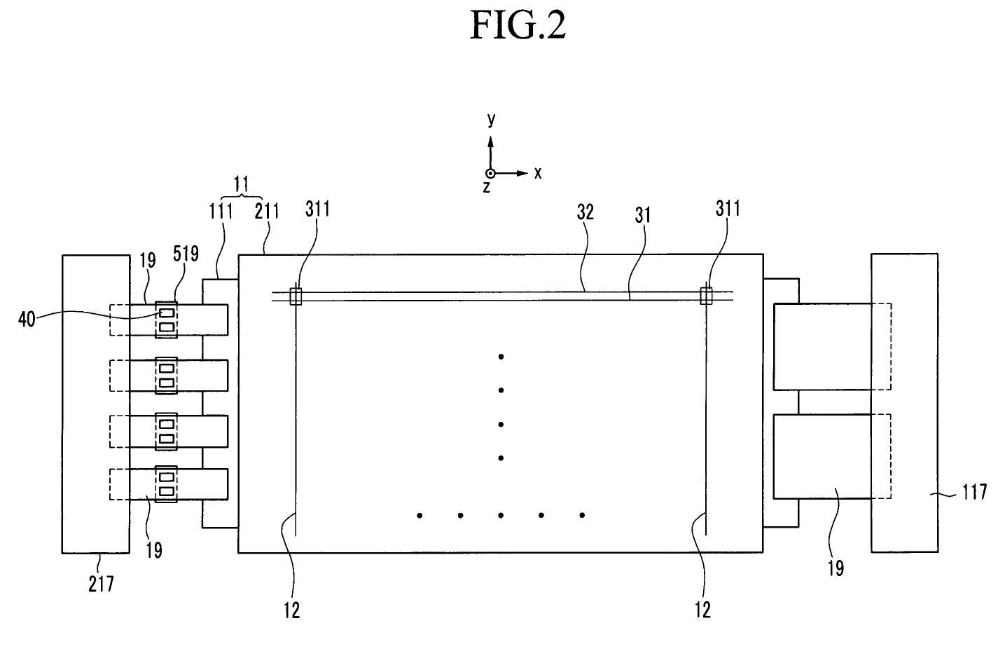

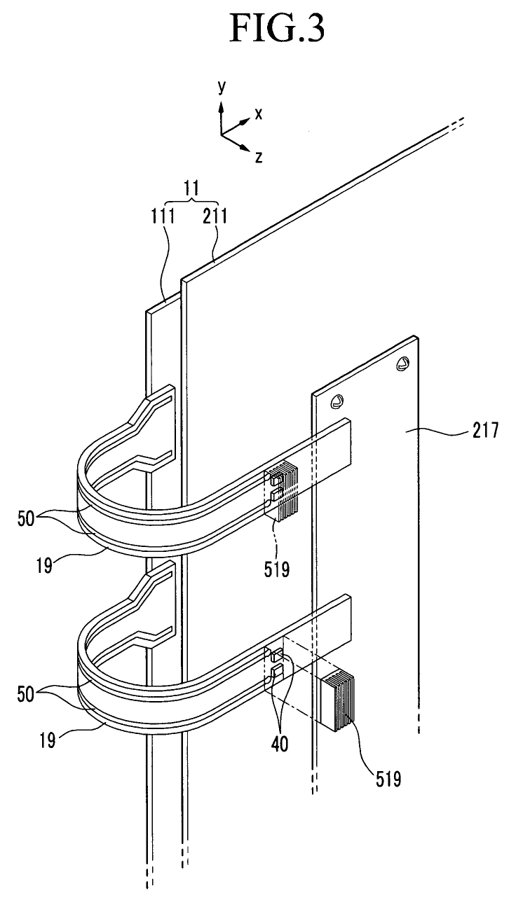

FIG. 2 is a front view of the PDP, a sustain board, and a scan board of FIG. 1, which are connected by the FPCs and are unfolded, and FIG. 3 is a partial perspective view of the PDP and scan board of FIG. 1, which are connected by the FPCs.

Referring to FIGS. 2 and 3, the PDP 11 includes a front substrate 111, a rear substrate 211, sustain electrodes 31, scan electrodes 32, and address electrodes 12. The sustain, scan, and address electrodes 31, 32, and 12 are arranged to induce gas discharge in discharge cells 311 formed between the front and rear substrates 111 and 211.

The address electrodes 12 intersect the scan electrodes 32 at regions corresponding to discharge cells 311 in order to select the discharge cells that will be turned on. The sustain electrodes 31 and the scan electrodes 32 are arranged in parallel with each other to realize an image on the selected discharge cells 311. The address electrodes 12 extend in a y-axis direction and the sustain and scan electrodes 31 and 32 extend in an x-axis direction.

Referring again to FIG. 1, heat dissipation sheets 13 are provided on a rear surface of the PDP 11 to dissipate heat generated by the PDP.

As an example, the heat dissipation sheets 13 may be formed of a variety of materials such as an acryl-based heat dissipation material, a graphite-based heat dissipation material, a metal-based heat dissipation material, and a carbon nanotube-based heat dissipation material.

The chassis base 15 is adhered to the rear surface of the PDP 11 by a double-sided adhesive tape 14 with the heat dissipation sheets 13 interposed between them.

The PCBs 17 are mounted on a rear surface of the chassis base 15 and are electrically connected to the PDP 11 to drive the PDP 11. The PCBs 17 are disposed on bosses (not shown) formed on the chassis base 15 and fixed to the bosses by setscrews 28. The PCBs 17 have different functions for driving the PDP 11.

For example, the PCBs 17 include a sustain board 117 for controlling the sustain electrodes 31, a scan board 217 for controlling the scan electrodes 32, and an address buffer board 317 for controlling the address electrodes 12.

The PCBs 17 further include an image processing/control board 417 for receiving external video signals, generating control signals required for driving the address electrodes 12 and control signals required for driving the sustain and scan electrodes 31 and 32, and applying the control signals to the corresponding PCBs, and a power supply board 517 for supplying electrical power required for driving the boards 117, 217, 317, and 417.

The FPCs 19 include FPCs for connecting the sustain board 117 to the sustain electrodes 31, FPCs for connecting the scan board 217 to the scan electrodes 32, and FPCs for connecting the address buffer board 317 to the address electrodes 12. In the present exemplary embodiment, the FPCs 19 for connecting the scan board 217 to the scan electrodes 32 will be exemplarily described.

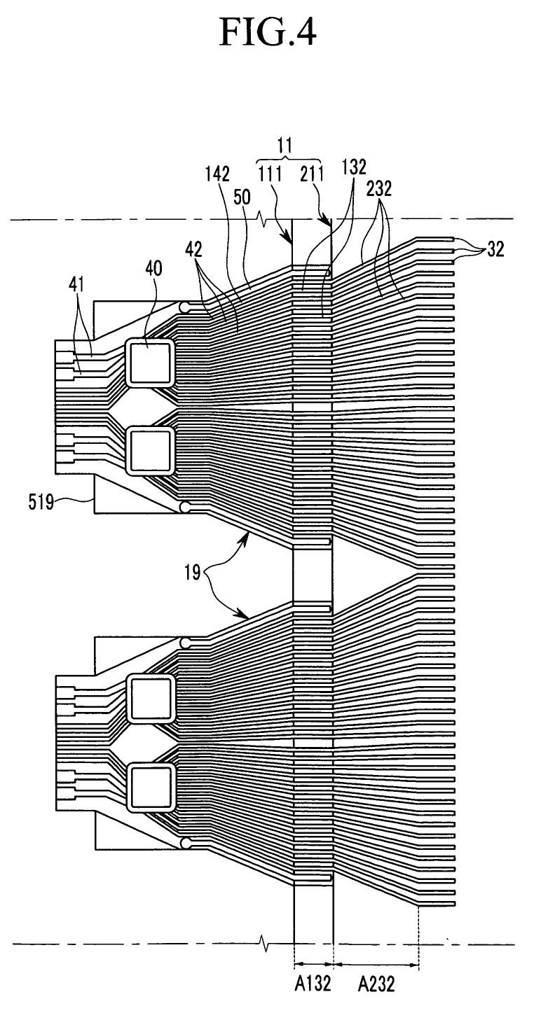

FIG. 4 is a detailed view illustrating a connection state of the FPCs and scan electrodes of FIG. 1.

Referring to FIG. 4, each of the FPCs 19 includes input lines 41 mounting scan ICs 40 and connected to the scan board 217, output lines 42 connecting the scan ICs 40 to the scan electrodes 32, and ground lines 50 disposed at outer sides of the respective outermost output lines 42.

The ground lines 50 ground the scan ICs 40 rather than the entire plasma display device. Since the ground of the scan ICs 40 is realized in a floating state, the ground of the scan ICs 40 may be referred to as “floating ground.”

In more detail, the ground of the scan ICs 40 includes a power output ground, a logic ground, and a substrate ground. In the present exemplary embodiment, the ground is the power output ground.

The input lines 41 transfer control signals of the scan board 217 to the scan ICs 40, and the scan ICs 40 generate a voltage output waveform for controlling the scan electrodes 32 in accordance with input signals from the scan board 217. The output lines 42 transfer the voltage output waveform generated by the scan ICs 40 to the scan electrodes 32.

The scan electrodes 32 select the discharge cells 311 that will be turned on by address discharge between the scan electrodes 32 and the address electrodes 12 in accordance with the voltage output waveform from the scan ICs 40.

Each of the scan electrodes 32 includes a terminal 132 extending from an edge of the front substrate 111 to an inside of the front substrate 111, and an interconnection line 232. The terminal 132 is connected to the corresponding output line 42 of the FPC 19, and the interconnection line 232 connects the terminal 132 to the corresponding scan electrode 32 at an edges of a region where the front and rear substrates 111 and 211 overlap.

For convenience, a region where the terminals 132 are formed will be referred to as “terminal region A132” and a region where the interconnection lines 232 are formed will be referred to as “interconnection regions A232.” That is, the PDP 11 (i.e., the front substrate 111) includes the terminal and interconnection regions A132 and A232.

The ground lines 50 are respectively formed beside outer sides of the outermost output lines 142 of the FPC 19. In the FPC 19, the ground lines 50 are arranged in parallel with the respective outermost output lines 142 at predetermined intervals, and extend from a region where the scan ICs 40 are formed to the terminal region A132.

Each of the FPCs 19 includes a heat dissipation member 519 attached to first surfaces of the scan ICs 40 to dissipate heat generated by a switching operation of the scan ICs 40. The ground lines 50 extend to be connected to the heat dissipation member 519, thereby grounding the scan ICs 40. The FPC 19 mounting the scan ICs 40 may be one of a chip-on-film (COF) and a tape carrier package (TCP).

The ground lines 50 provide an electrostatic shielding effect to the outermost output lines 142. The width of the ground line 50 may be greater than that of the outermost output line 142.

The electrostatic shielding effect by the ground lines 50 prevents or reduces the fluctuation of the voltage output waveform of the outermost output lines 142. That is, the electrostatic shielding effect prevents the fluctuation of the voltage output waveform of the outermost output lines 142 or reduces the fluctuation to a level that is similar to that of the inner output lines 42 between the outermost output lines 142.

Since the fluctuation of the voltage output waveform is prevented or reduced as described above, the fluctuation of the discharge time of the discharge cells 311 of the scan electrodes 32 connected to the outmost output lines 142 is prevented or reduced.

Therefore, there is no luminance difference between the scan electrodes 32 connected to the outermost output lines 142 and the scan electrodes 32 connected to the inner output lines 42.

As a result, with reference to the two adjacent FPCs 19, the scan electrodes 32 connected to the outermost output lines 142 of the first FPC 19 and the scan electrodes 32 connected to the outermost output lines 142 of the second FPC 19 induce the same luminance as that induced by the scan electrodes 32 connected to the inner output lines 42 of the first and second FPCs 19. Therefore, the horizontal image streaking of the PDP 11 can be prevented.

The ground lines 50 are formed on the FPC 19 and connected to the terminal region A132 of the front substrate 111. At this point, a separate ground pattern (not shown) connected to the ground lines 50 of the FPC 19 may be formed on the terminal region A132 of the front substrate 111. In this case, the ground lines 50 and the ground pattern overlap each other at the terminal region A132.

The following will describe a variety of other exemplary embodiments. Parts similar or identical to those of the first exemplary embodiment will not be described in detail.

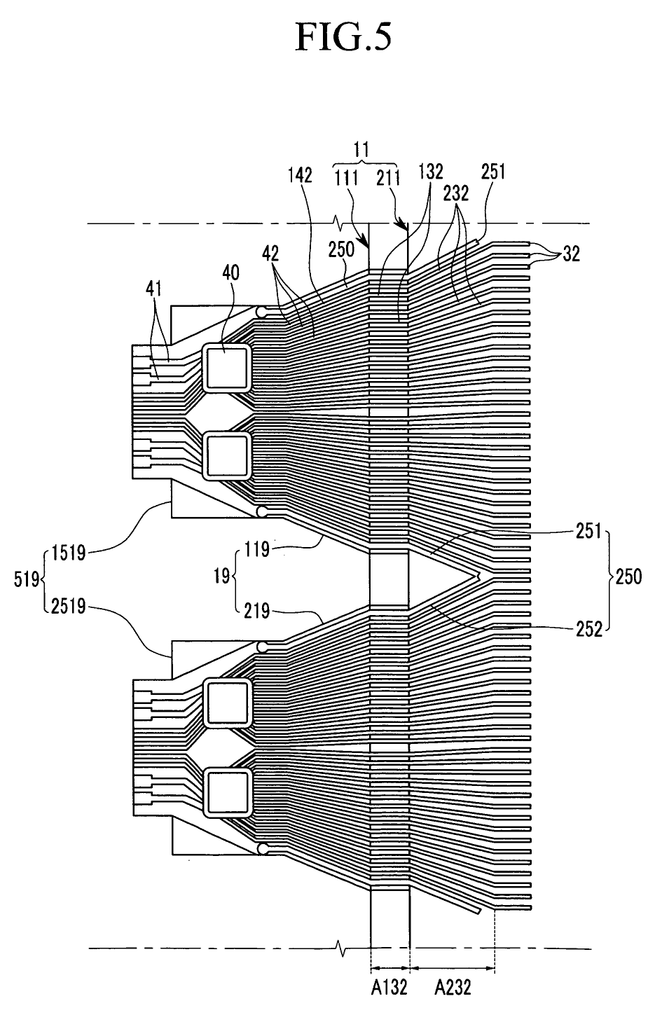

FIG. 5 is a detailed view illustrating a connection state between FPCs and scan electrodes of a plasma display device according to a second exemplary embodiment.

Referring to FIG. 5, each ground line 250 has a first extending portion 251 and a second extending portion 252. The first and second extending portions 251 and 252 extend from a terminal region A132 of a front substrate 111 to an interconnection line region A232.

Therefore, the ground lines 250 of the second exemplary embodiment can provide an electrostatic shielding effect for the interconnection line region A232 as well as outermost output lines 142 and the terminal region A132.

FPCs 19 include first and second FPCs 119 and 219 adjacent to each other. Therefore, the extending portions of the ground lines 250 of the first FPC 119 will be referred to as “first extending portions 251,” and the extending portions of the ground lines 250 of the second FPC 219 will be referred to as “second extending portions 252.”

That is, the first and second extending lines 251 and 252 extend from the terminal region A132 to the interconnection line region A232. The first extending portion 251 of the ground line 250 of the first FPC 119 and the second extending portion 252 of the ground line 250 of the second FPC 219 are adjoined to each other at the interconnection line region A232.

Meanwhile, the heat dissipation member 519 includes a first heat dissipation member 1519 and a second heat dissipation member 2519 that are installed to respectively correspond to the first and second FPCs 119 and 219.

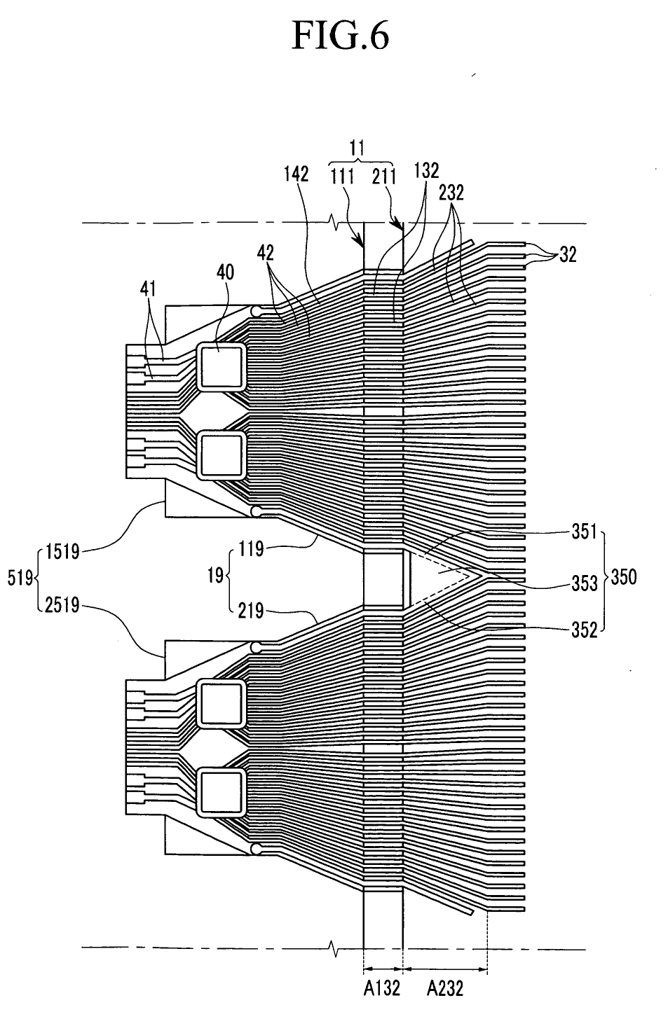

FIG. 6 is a detailed view illustrating a connection state between FPCs and scan electrodes of a plasma display device according to a third exemplary embodiment.

Referring to FIG. 6, in a plasma display device in accordance with a third exemplary embodiment, first and second extending portions 351 and 352 of ground lines 350 are connected to an enlarged portion 353 formed at an interconnection line region A232. That is, the enlarged portion 353 is enlarged on the interconnection line region A232 of a front substrate 111 to interconnect the first and second extending portions 351 and 352.

Therefore, the ground lines 350 of the third exemplary embodiment can provide an electrostatic shielding effect for the outermost output lines 142, terminal region A132, and interconnection line region A232.

The enlarged portion 353 further enhances the electrostatic shielding effect at the interconnection line region A232.

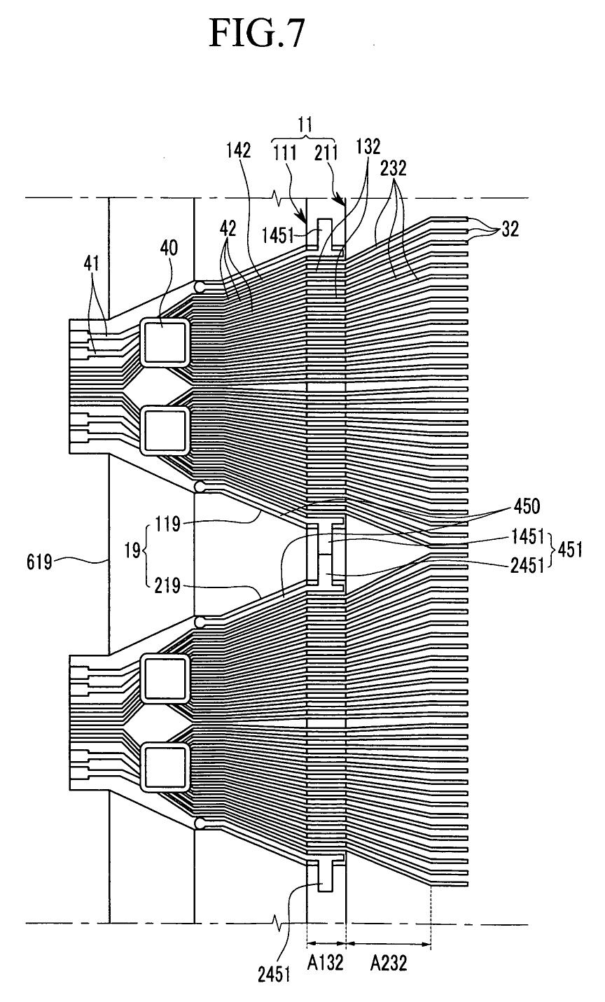

FIG. 7 is a detailed view illustrating a connection state between FPCs and scan electrodes of a plasma display device according to a fourth exemplary embodiment.

Referring to FIG. 7, in a plasma display device in accordance with a fourth exemplary embodiment, ground lines 450 include an enlarged portion 451 enlarged at the terminal region A132 of a front substrate 111.

The enlarged portion 451 includes a first enlarged portion 1451 connected to the ground line 450 of the first FPC 119 and a second enlarged portion 2451 connected to the ground line 450 of the second FPC 219. The first and second enlarged portions 1451 and 2451 are interconnected at the terminal region A132.

Therefore, the ground lines 450 of the fourth exemplary embodiment enhance the electrostatic shielding effect for the terminal region A132.

A heat dissipation member 619 may be provided in the form of a single unit to simultaneously cover the first and second FPCs 119 and 219 adjacent to each other. Since an area of the heat dissipation member 619 of the fourth exemplary embodiment is greater than those of the heat dissipation members 510 of the foregoing exemplary embodiments, the heat generated by the scan ICs 40 can be more effectively dissipated.

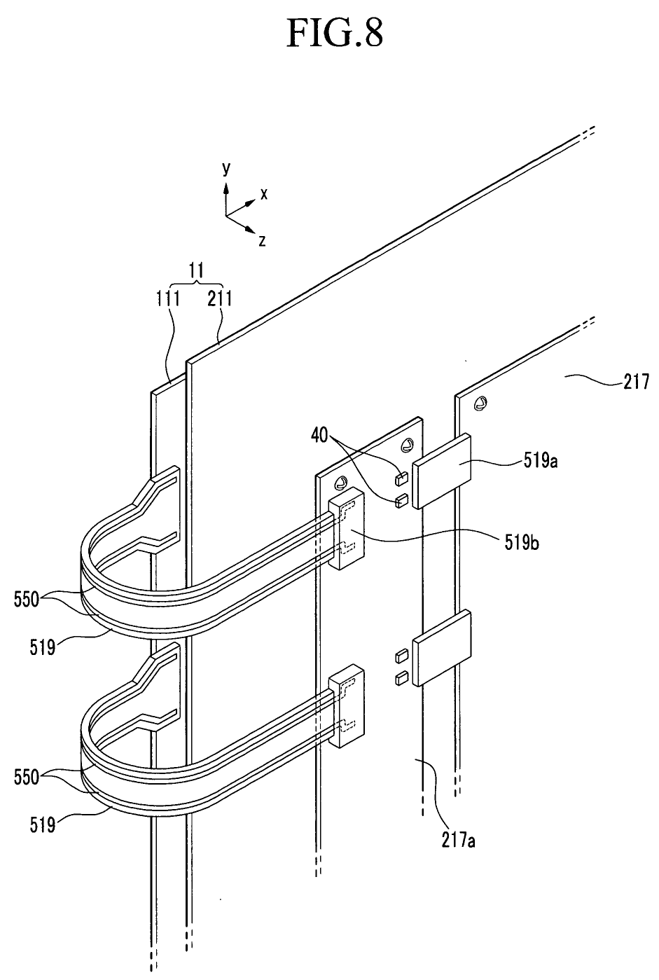

FIG. 8 is a partial perspective view illustrating a connection state of a PDP, a scan buffer board, and a scan board by FPCs in a plasma display device according to a fifth embodiment of the present invention.

Referring to FIG. 8, a scan board 217 is connected to scan electrodes (not shown) with a scan buffer board 217a interposed between the scan board 217 and the scan electrodes 32. Scan ICs 40 are mounted on the scan buffer board 217a. The scan buffer board 217a is connected to the scan board 217.

Each FPC 519 has a first end connected to the scan electrodes and a second end connected to the scan buffer board 217a by a connector 519b. The FPC 519 includes output lines (not shown) and ground lines 550. The output lines connect the scan ICs 40 to the scan electrodes. The ground lines 550 are grounded to the scan buffer board 217a through the connector 519b and the scan buffer board 217a is connected to the scan board 217 by other FPCs 519a.

Therefore, the ground lines 550 of the fifth exemplary embodiment can provide the electrostatic shielding effect for the outermost output lines of the FPC 519 connecting the scan electrodes to the scan buffer board 217a.

According to the exemplary embodiments of the present disclosure, since the ground lines are formed at the outsides of the outermost output lines of the scan ICs mounted on the FPC connecting the scan electrodes to the PCB, the electrostatic shielding effect can be obtained and thus the fluctuation of the output voltage of the outermost output lines can be prevented or reduced.

Therefore, there is no luminance difference between the scan electrodes connected to the outermost output lines and the scan electrodes connected to the inner output lines between the outermost output lines.

Further, since the ground lines are formed at the outsides of the outermost output lines of the scan ICs mounted on two adjacent FPCs connecting the scan electrodes to the PCB, the electrostatic shielding effect can be obtained and thus the fluctuation of the output voltage of the adjacent outermost output lines of the FPCs can be prevented or reduced.

Therefore, there is no luminance difference between the scan electrodes connected to the two adjacent outermost output lines and the scan electrodes connected to the other output lines. As a result, the horizontal image streaking of the PDP can be prevented.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma display device comprising:
a plasma display panel comprising sustain electrodes, scan electrodes, and address electrodes, which are arranged to correspond to discharge cells to selectively drive at least one of the discharge cells;
a chassis base supporting the plasma display panel;
at least one printed circuit board mounted on the chassis base; and
at least one flexible printed circuit connecting the scan electrodes to the printed circuit board,
wherein the flexible printed circuit comprises
a plurality of input lines connecting at least one scan integrated circuit to the printed circuit board,
a plurality of output lines connecting the at least one integrated circuit to the scan electrodes, and
ground lines that are formed beside outer sides of outermost output lines among the output lines to ground the at least one scan integrated circuit.

2. The plasma display device of claim 1, wherein each of the scan electrodes comprises a terminal and an interconnection line connected to the terminal line,
the plasma display panel comprises a terminal region where the terminals are formed and an interconnection line region where the interconnection lines are formed, and
the ground lines are in parallel with the outermost output lines at predetermined intervals and extend from the scan IC to the terminal region.

3. The plasma display device of claim 2, wherein each of the ground lines has a first extending portion extending from the terminal region to the interconnection line.

4. The plasma display device of claim 3, wherein the at least one flexible printed circuit comprises a first flexible printed circuit and a second flexible printed circuit that are adjacent to each other, and
the extending portions of the adjacent ground lines of the first and second flexible printed circuits are connected to each other.

5. The plasma display device of claim 4, wherein the extending portions of the adjacent ground lines of the first and second flexible printed circuits are connected to an enlarged portion formed at the interconnection line region.

6. The plasma display device of claim 2, wherein each of the ground lines comprises an enlarged portion formed at the terminal region.

7. The plasma display device of claim 6, wherein the at least one flexible printed circuit comprises a first flexible printed circuit and a second flexible printed circuit that are adjacent to each other, wherein the enlarged portions include a first enlarged portion and a second enlarged portion connected to each other, the first enlarged portion connected to the ground line of the first flexible printed circuit and the second enlarged portion connected to the ground line of the second flexible printed circuit.

8. The plasma display device of claim 2, wherein a width of each of the ground lines is greater than that of each of the output lines.

9. The plasma display device of claim 1, further comprising a heat dissipation member attached on a surface of the at least one scan integrated circuit.

10. The plasma display device of claim 9, wherein the ground lines penetrate the flexible printed circuit and are grounded to the heat dissipation member.

11. The plasma display device of claim 9, wherein the at least one flexible printed circuit comprises first and second flexible printed circuits adjacent to each other, wherein the heat dissipation member comprises first and second heat dissipation members respectively corresponding to the first and second flexible printed circuits.

12. The plasma display device of claim 9, wherein the at least one flexible printed circuit comprises first and second flexible printed circuits adjacent to each other, wherein the heat dissipation member is provided in the form of a single unit that simultaneously covers the first and second flexible printed circuits.

13. The plasma display device of claim 1, wherein the flexible printed circuit mounting the at least one scan integrated circuit is one of a chip-on-film (COF) and a tape carrier package (TCP).

14. A plasma display device comprising:
a plasma display panel comprising sustain electrodes, scan electrodes, and address electrodes, which are arranged to correspond to discharge cells to selectively drive at least one of the discharge cells;
a chassis base supporting the plasma display panel;
a scan board mounted on the chassis base;
a scan buffer board mounting at least one scan integrated circuit and connected to the scan board; and
at least one flexible circuit board connecting the scan electrodes to the scan buffer board,
wherein the flexible printed circuit comprises
a plurality of output lines connecting the at least one integrated circuit to the scan electrodes, and
ground lines that are respectively formed beside outer sides of outermost output lines among the output lines to ground the at least one scan integrated circuit.

15. The plasma display device of claim 14, wherein the ground lines are grounded to the scan buffer board.

16. A plasma display device comprising:
a plasma display panel comprising sustain electrodes, scan electrodes, and address electrodes, which are arranged to correspond to discharge cells to selectively drive at least one of the discharge cells;
a chassis base supporting the plasma display panel;
a scan board mounted on the chassis base;
a scan buffer board mounting at least one scan integrated circuit and connected to the scan board; and
at least one flexible circuit board connecting the scan electrodes to the scan buffer board,
wherein the flexible printed circuit comprises
a plurality of output lines connecting the at least one integrated circuit to the scan electrodes, and
ground lines that are respectively formed beside outer sides of outermost output lines among the output lines to ground the at least one scan integrated circuit,
wherein the ground lines are grounded to the scan buffer board providing an electrostatic shielding effect.
